(19) United States
(12) Patent Application Publication
(10) Pub. No.: US 2023/0182069 A1
(43) Pub. Date: Jun. 15, 2023

(54) HYDROGEN SULFIDE SCAVENGING COMPOSITIONS WITH SUPRAMOLECULAR STRUCTURES AND METHODS OF USE

(71) Applicant: BPS JUST ENERGY TECHNOLOGY, LLC, Argyle, TX (US)

(72) Inventors: Derek E. VAUGHN, Fulshear, TX (US); Jason L. HURST, Roanoke, TX (US); Robert A. GEIGER, Denton, TX (US)

(21) Appl. No.: 18/165,898

(22) Filed: Feb. 7, 2023

Related U.S. Application Data
(63) Continuation of application No. PCT/US2021/045226, filed on Aug. 9, 2021.
(60) Provisional application No. 63/063,611, filed on Aug. 10, 2020.

(51) Int. Cl. B01D 53/14; B01D 53/52; B01D 53/78

(52) U.S. Cl. CPC B01D 53/1493; B01D 53/1468; B01D 53/52; B01D 53/78; B01D 2252/20436; B01D 2252/60; B01D 2252/502

(57) ABSTRACT

Compositions with supramolecular structures for use in oil and gas production and other applications include an H₂S scavenger, a supramolecular host chemical or a supramolecular guest chemical configured to engage in host-guest chemistry with the scavenger, and a solvent. Methods of controlling H₂S at a production site include applying an effective amount of the composition to the production stream.

### CROSS-REFERENCE TO RELATED APPLICATIONS

This application is a continuation of PCT Patent Application No. PCT/US2021/045226, filed Aug. 9, 2021, currently pending, which claims the benefit of U.S. Provisional Patent Application No. 63/063,611, filed Aug. 10, 2020, now expired, the entire contents of each of which is hereby incorporated herein in its entirety by express reference thereto.

### BACKGROUND OF THE DISCLOSURE

Hydrogen sulfide (1425) gas is a toxic gas problem prevalent in the hydrocarbon processing industry. The removal of sulfur-based species from liquid or gaseous hydrocarbon streams is a problem that has long challenged many industries. Hydrogen sulfide is a problem in the oil industry, particularly in the drilling, production, transportation, storage, and processing of crude oil, as well as wastewater associated with crude oil. The same problems exist in the natural gas industry and in geothermal power plants.

The necessity and importance of treating H₂S gas persists despite boom-and-bust cycles or rapid advancements in the technology used to acquire oil and gas. This is largely due to the toxicity and corrosivity of H₂S gas, or sour gas, which has been responsible for the deaths of hundreds of oilfield workers in the U.S. and other oil-producing countries over the last 20 years. As such, the need for continuous improvement in the chemicals, methods, and processes used for removing and treating H₂S gas is critical to reduce the number of yearly deaths caused by sour gas.

Several different methods for treating H₂S are currently in use, and include physical methods such as venting, flaring, or stripping, and chemical methods such as absorption and oxidation. The chemical methods can be divided into regenerative and non-regenerative methods. Regenerative scavengers undergo reversible reactions with H₂S and include alkylamines and alkanolamines, with methyl diethanolamine (MDEA) being the most common due to its specificity for H₂S. Non-regenerative methods include the use of triazines, oxidizers, solid materials containing zinc or iron, aldehydes (mainly glyoxal), and metal carboxylates and chelates.

The primary drawbacks to using chemical methods include cost, poor scavenging efficiency, and the propensity for overspent scavenger to drop large amounts of solids from solution. In the case of monoethanoloamine (MEA) triazine this solid is known as dithiazine. It is produced when 2 moles of H₂S react with 1 mole of MEA triazine, which displaces 2 moles of ethanolamine from the MEA triazine molecule leaving dithiazine.

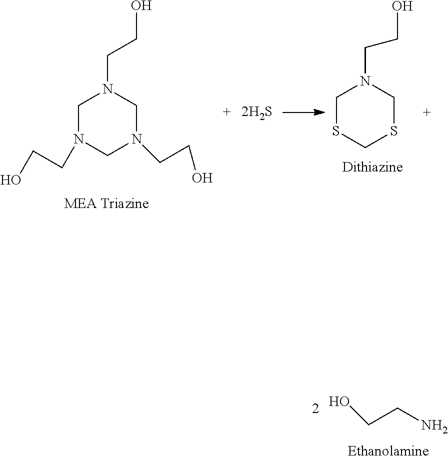

Dithiazine is less soluble in water than it is in MEA triazine, so as the scavenger reacts with more and more H₂S the ratio of MEA triazine to water will drop. Eventually the scavenger will reach an overspent condition and no more dithiazine will stay in solution. At this point, a lower organic layer of dithiazine will begin to form. This layer will eventually completely solidify, and these solids must then be disposed of as waste. This leaves behind a significant amount of unused scavenger (20-40%) that must be treated as waste, in addition to the waste-disposal problem and the cost of such disposal.

Thus, it would be beneficial to have a composition with increased efficiency and H₂S scavenging capacity. This would allow more of the composition to be used before it needs to be replaced, which would save time, reduce waste, and increase the cost effectiveness of the product.

### BRIEF DESCRIPTION OF THE DRAWINGS

The present disclosure is best understood from the following detailed description when read with the accompanying figures.

FIG. 1 is a microscope image of the supramolecular structure from Composition 5 of Example 1, according to aspects of the present disclosure;

FIG. 2 is a microscope image of the control composition in Example 1;

FIG. 3 illustrates the scavenging performance results of the compositions of Example 1, according to aspects of the present disclosure;

FIG. 4 illustrates the runtime performance results of the compositions of Example 1, according to aspects of the present disclosure;

FIG. 5 illustrates the scavenging performance results of the compositions of Example 4, according to aspects of the present disclosure; and

FIG. 6 illustrates the runtime performance results of the compositions of Example 4, according to aspects of the present disclosure.

### DETAILED DESCRIPTION

The present disclosure provides compositions and methods that address the need for an H₂S scavenging composition capable of increasing active ingredient assimilation and increasing performance overall without adding negative health or environmental impacts, and which can be applied using standard industry practices. The present disclosure describes H₂S scavengers that form supramolecular structures when mixed with a supramolecular host or guest chemical configured to engage in host-guest chemistry with the scavenger. The resulting compositions increase the scavenger's efficiency, e.g., the compositions convert more H₂S per gallon of scavenger, thereby reducing the amount of scavenger needed per pound of H₂S.

An unexpected benefit of the present compositions is the substantial reduction in unwanted precipitated solids that is normally observed when certain conventional chemistries are reacted (spent) beyond a threshold value. In some embodiments, unwanted precipitated solids are present at amounts less than about 5% w/w of the H₂S scavenger within the system being treated, such as less than about 3% w/w, less than about 1% w/w, or less than about 0.5% w/w. In an exemplary embodiment, unwanted precipitated solids are present at amounts less than about 0.1% w/w of the H₂S scavenger within the system being treated. As used herein, “about” is meant to encompass variations of up to ±10% of the stated amount.

Advantageously, the compositions have an enhanced synergy that provides increased active ingredient assimilation, stability, and performance without introducing undesirable attributes. Application of the compositions to wells, tanks, and flow lines containing H₂S results in a dramatic increase in efficiency, or an increase in the amount of H₂S that can be treated, with each gallon of scavenger. The compositions can be applied by direct injection to a flow line, pre-loading into a bubble tower, spray atomization, or other methods known to those of ordinary skill in the art. The present compositions inhibit, and can prevent, unwanted solids from forming solid deposits in the tower or the pipeline, thereby prolonging equipment operation time and improving H₂S removal.

In various embodiments, the compositions include (1) an H₂S scavenger and (2) a supramolecular host or guest chemical configured to engage in host-guest chemistry with the scavenger. The formation of supramolecular structures between these components in the compositions promotes an increased efficiency and/or stability and/or reduced precipitation that is dependent on the type of scavenger. Such supramolecular structures or assemblies may take the form of, e.g., micelles, liposomes, sub-micron structures, or micron bubbles. As used herein, “H₂S scavenger” or “scavenger” means any compound or mixture that reacts with one or more sulfide species to convert the one or more sulfide species to a more inert form or a form that can be more easily separated from the equipment or hydrocarbon fluid.

In several embodiments, the scavenger includes one or more of the following categories, and may include one or more item from within each category: (1) an alkylamine or alkanolamine, (2) an aldehyde, (3) the reaction product between (a) an alkylamine or (a′) alkanolamine and (b) an aldehyde, (4) an oxidizer, (5) a transition metal salt, a transition metal carboxylate, or a transition metal oxide where the transition metal is either iron or zinc, or (6) a caustic; or any combination thereof. The alkylamines and alkanolamines can include methylamine, ethylamine, diethylamine, diisopropylamine, ethylenediamine, monoethanolamine, diethanolamine, N-methyldiethanolamine, diglycolamine, or any combination thereof. Aldehydes can include formaldehyde, benzaldehyde, cinnamaldehyde, vanillin, acetaldehyde, glyoxal, or any combination thereof. The reaction products between alkylamines, alkanolamines and aldehydes consists mainly of MEA triazine and monomethylamine (MMA) triazine, but numerous constructions can be obtained which are readily apparent to those of ordinary skill in the art. Oxidizers can include, but not necessarily limited to, chlorine dioxide, hydrogen peroxide, sodium hypochlorite, sodium bromate, sodium nitrite, or any combination thereof. Suitable transition metal salts, transition metal carboxylates, and transition metal oxides include zinc oxide, zinc carbonate, basic zinc carbonate, zinc chloride, zinc acetate, zinc octoate, zinc hydrocarbyl phosphate, zinc ethyl hexanoate (zinc 2-hexanoate), zinc naphthenates, zinc oleate, zinc carboxylate polymers (e.g., catena-2-ethylhexananto-(O,O′)-tri-μ-2-ethylhexanato(O,O′) dizinc (II)), iron oxides, iron chloride, iron carboxylates (e.g., iron oleate), iron neocarboxylates (e.g., iron 2-ethyl hexanoate), iron naphthenates, or any combination thereof. Caustics can include, but are not necessarily limited to, sodium hydroxide, potassium hydroxide, or any combination thereof.

Additional formulation aids such as one or more sequestrants, scale inhibitors, surfactants, corrosion inhibitors, solvents, anti-foamers, freeze point depressants, pour point depressants, diluents, or any combination of categories or component(s) within each category thereof, can be added by as much as 40% w/w, but are preferably added between about 10% and about 30% w/w. Sequestrants are used to sequester calcium and magnesium and can include, but are not necessarily limited to, salts of ethylenediaminetetraacetic acid (EDTA), diethylenetriaminepentaacetic acid, nitrilotriacetic acid, N-hydroxyethylethylenediaminetriacetic acid, glutamic acid, N,N-diacetic acid, methylglycine N,N-diacetic acid, sodium glucoheptonate, ethanoldiglycine, or any combination thereof. Scale inhibitors used in combination can include, but are not necessarily limited to, diethylenetriamine penta(methylene phosphonic acid), bis(hexamethylene triamine penta(methylene phosphonic acid)), aminomethylene phosphonic acid, amino tris (methylenephosphonic acid), phosphonobutane tricarboxylic acid, aminoethylethanolamine (AEEA) phosphonic acid and their salts, triethanolamine phosphate ester, polymeric scale inhibitors such as polycarboxylates, or any combination thereof. Corrosion inhibitors used can include, but are not necessarily limited to, amines, imidazolines, and quaternary ammonium salts, or any combination thereof. Surfactants can include any nonionic or anionic surfactant that can incorporate oil-based components of the scavenger into a predominantly aqueous carrier. Suitable nonionic surfactants include linear alcohol ethoxylates with a hydrophile-lipophile balance (HLB) number greater than about 11.5. Suitable anionic surfactants include various salts of dodecylbenzene sulfonic acid, such as the triethanolamine salt or the triisopropylamine salt. An exemplary embodiment combines the triethanolamine salt of dodecyl benzene sulfonic acid (DDBSA) with a linear alcohol ethoxylate having an 11-carbon chain and 7 moles of ethoxylation in a 2:1 ratio of anionic to nonionic.

Solvents are generally used to decrease viscosity, increase solubility, or decrease surface tension, or a combination of reasons. Any solvent may be used, including for example water, any alcohol, or mutual solvents such as glycol ethers and dibasic esters. Typically, an aqueous solvent is used such as water, alcohols (i.e., methanol, ethanol, and isopropanol), aldehydes (i.e., formaldehyde, acetaldehyde, and acetone), nitriles, ketones, and ether solvents. Water or alcohol/water mixtures are a preferred solvent. In an exemplary embodiment, the solvent includes water and at least one alcohol. For example, the alcohol may include methanol. The alcohol (e.g., methanol) may be present in the water in an amount of about 1 to about 25 weight percent, such as about 5 to about 20 weight percent. In one embodiment, the solvent includes water with methanol at a concentration of about 10 weight percent. In another exemplary embodiment, the solvent includes water, methanol, ethanol, or a combination thereof.

Water (or other polar solvent) is present in any suitable amount but is generally present in the composition in an amount of about 0.5 percent to about 80 percent by weight of the composition. In certain embodiments, water is present in an amount of about 5 percent to about 75 percent by weight of the composition, for example, about 50 percent to about 70 percent by weight of the composition.

Anti-foamers are used to control foam caused by the surfactants and include silicone-based emulsions such as Xiameter™ AFE-1410 antifoam emulsion, which is commercially available from The Dow Chemical Company.

Freeze point depressants are chemical compounds added to a liquid to lower its freezing temperature. Suitable examples include, but are not necessarily limited to, alcohols (e.g., methanol), ethylene glycol, propylene glycol, or any combination thereof.

Pour point depressants are polymers that allow oil and lubricants to flow at very low wintertime temperatures without heavy wax formation at cold temperatures and enable the oil to remain pumpable. Suitable examples include, but are not necessarily limited to, any alkylaromatic or aliphatic polymer, or any combination thereof.

Diluents refer to any liquid substance that is mixed with a sample to reduce its viscosity and increase its flow rate. Suitable examples include, but are not necessarily limited to, water, alcohols (e.g., methanol), or any combination thereof.

The H₂S scavenger is present in any suitable amount but is generally present in the composition in the amount of about 1 percent to about 90 percent by weight of the composition. In some embodiments, the scavenger is present in an amount of about 10 percent to about 85 percent, for example 20 percent to about 80 percent, by weight of the composition. In exemplary embodiments, the scavenger is present in an amount of about 20 percent to about 60 percent by weight of the composition, for example, about 20 percent to about 40 percent by weight of the composition.

In selecting suitable supramolecular host or guest chemical(s), (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with a solvent. A preferred solvent includes an aqueous solvent such as water. In some embodiments, a water or oil suspension can be formulated. Host chemicals may include particles greater than 100 nm of various elements and compounds, which may have a charge, may have magnetic properties, or both, but preferably not including nanostructures or nanoparticles. Suitable supramolecular host chemicals include cavitands, cryptands, rotaxanes, catenanes, or any combination thereof.

Cavitands are container-shaped molecules that can engage in host-guest chemistry with guest molecules of a complementary shape and size. Examples of cavitands include cyclodextrins, calixarenes, pillarrenes, and cucurbiturils. Calixarenes are cyclic oligomers, which may be obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH₂]3N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another, but cannot be separated unless covalent bond breakage occurs.

Suitable supramolecular guest chemicals include cyanuric acid, water, and melamine, and are preferably selected from cyanuric acid or melamine, or a combination thereof. Another category of guest chemical includes particles greater than 100 nm of various elements and compounds, which may have a charge, may have magnetic properties, or both, but preferably not including nanostructures or nanoparticles.

The supramolecular host chemical or the supramolecular guest chemical is present in the composition in any suitable amount but is generally present in the composition in an amount of about 1 percent to about 90 percent by weight of the composition. In certain embodiments, the supramolecular host chemical or supramolecular guest chemical, or host and guest chemical combination, is present in an amount of about 50 percent to about 85 percent by weight of the composition, for example, about 60 percent to about 80 percent by weight of the composition.

The order of addition of the components of the composition can be important to obtain stable supramolecular structures or assemblies in the final mixture. The order of addition is typically: (1) a solvent and (2) a scavenger. Once these two components are fully mixed, the supramolecular host or guest chemical is added to the mixture and allowed to mix thoroughly with the other components.

The amount of the composition used for scavenging may vary based on the amount of H₂S present in the hydrocarbon fluid being treated. The hydrocarbon fluid can be a liquid or a gas. The present compositions are typically applied as a 40% w/w solution either as a continuous injection into a flow line, or as a 40% w/w solution, which can be prepared for example in a batch size of approximately 2500 gallons. In some embodiments, the compositions are applied as an about 20% w/w (e.g., 25% w/w) solution to an about 60% w/w (e.g., 65% w/w) solution.

In various embodiments, the composition may be injected in the flow lines during the development stage of a field or in small producing fields, or a gas containing H₂S may be passed through an absorption tower where the composition has been injected. In some embodiments, the present compositions and methods may be used in scavenging H₂S from hydrocarbon fluids including crude oil, vacuum gas oil, fuel oil, distillate fuel, gasoline, diesel fuel, sour gas, and asphalts and refined products contained in storage tanks, vessels, or pipelines. As the hydrocarbon fluid contacts the composition, the H₂S in the hydrocarbon fluid reacts with the H₂S scavenger to reduce the amount of H₂S in the hydrocarbon fluid. Once the H₂S in the hydrocarbon fluid is converted to a different form by the scavenger, the reaction products may be removed by suitable methods known to those of ordinary skill in the art. For example, the vessel may be drained, and mechanical separation methods may be applied, followed by physical removal of the reaction products. For towers or scrubbers, this physical removal often means beginning with a high-pressure water blast (10,000 psi) of the internal compartments and baffles of the equipment, followed by manual removal of the remaining deposits using shovels. For pipelines, pigging is usually required to remove the accumulated deposits. However, pigging is only applicable to pipelines that are in good condition which can allow the pigging process.

The following examples are illustrative of the compositions and methods discussed above and are not intended to be limiting.

### EXAMPLES

### Example 1: Preparation of 40% MEA Triazine Compositions

Exemplary compositions were prepared using the components and quantities shown in Table 1 below. The compositions were made by using commercially available distilled water, MEA triazine, tetrasodium EDTA, and SymMAX™ supramolecular host water mixture commercially available from Shotwell Hydrogenics. Tetrasodium EDTA was added to the solution to chelate any hard-mineral ions that could precipitate from the SymMAX™ supramolecular host water mixture due to the high pH of MEA triazine.

A control composition was also prepared using the components and quantities shown in Table 1 below, but SymMAX™ supramolecular host water mixture was replaced with distilled water.

TABLE 1
COMPOSITION COMPONENTS AND AMOUNTS

| | Control | | | | | |
|---|---|---|---|---|---|---|
| | Composition 1 | Composition 1 | Composition 2 | Composition 3 | Composition 4 | Composition 5 |
| Component | (w/w %) | (w/w %) | (w/w %) | (w/w %) | (w/w %) | (w/w %) |
| Distilled water | 50.0% | 35.5% | 29.5% | 23.5% | 17.5% | 12.0% |
| MEA Triazine¹ | 50.0% | 50.0% | 50.0% | 50.0% | 50.0% | 50.0% |
| Tetrasodium | | 0.5% | 0.5% | 0.5% | 0.5% | 0.5% |
| EDTA² | | | | | | |
| SymMAX ™ | | 14.0% | 20.0% | 26.0% | 32.0% | 37.5% |
| supramolecular | | | | | | |
| host water | | | | | | |
| mixture³ | | | | | | |

¹Commercially available as Berrysweet-800000 from Berryman Chemical (80% MEA Triazine Water Solution)
²Commercially available as Dissolvine ® E39 from Nouryon (39% Tetrasodium EDTA Water Solution)
³Commercially available from Shotwell Hydrogenics, LLC

### Example 2: Microscope Images

Microscope images for the formation of supramolecular structures was completed by taking Composition 5 and rapidly drying onto a glass microscope slide. A microscope slide was prepared by cleaning with isopropanol and distilled water. Once dry, the microscope was wrapped with 10-micron filter paper. The filter paper was then used to absorb water in the mixture to ensure rapid drying to obtain microscope imagery of the supramolecular structures.

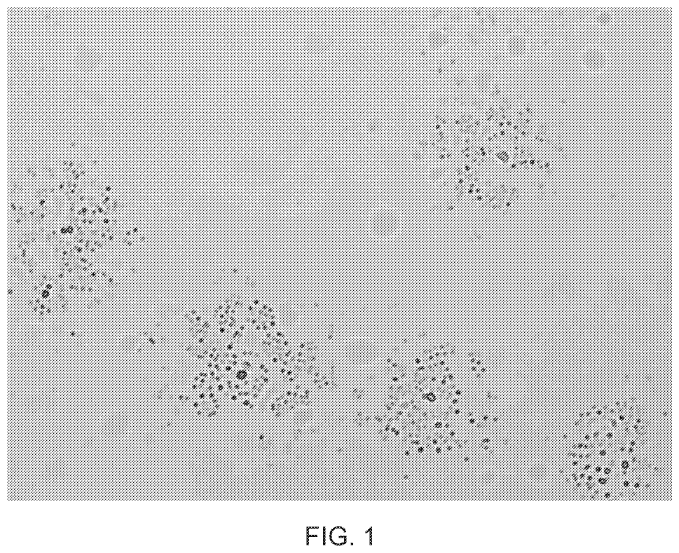

FIG. 1 is a 40× microscope image of the supramolecular structure from Composition 5 containing SymMAX™ supramolecular host water mixture. FIG. 1 shows clustering and localization of the active species in solution.

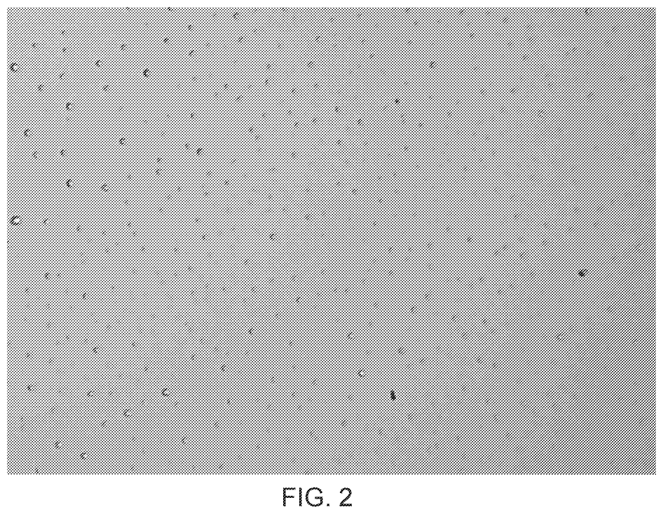

FIG. 2 is a 40× microscope image of Control Composition 1, which is 40% MEA triazine in distilled water, showing the triazine as small droplets.

### Example 3: Performance Test of Compositions of Example 1

The H₂S scavenging performance of the compositions in Example 1 were evaluated at a third-party laboratory (Lightning Corrosion Lab in Tomball, Tex.) according to the procedure described below. Samples were diluted with distilled water to achieve a 0.4% MEA triazine concentration in a 300 mL sample for testing. A gas cylinder containing 0.2% H₂S and 5% CO₂ in 94.8% v/v methane was connected to a sparge tube, which was immersed in the test sample. Gas was fed to the sparge tube at a rate of 475 cc/min, and effluent gases were routed to an H₂S monitor. The test was run until breakthrough, or the point at which the H₂S monitor recorded an H₂S concentration of 15 ppm. The amount of time taken to reach breakthrough was referred to as the runtime.

The amounts of H₂S scavenged, as well as the runtimes are provided in Table 2.

TABLE 2
EXAMPLE 1 COMPOSITIONS PERFORMANCE RESULTS

| | | H₂S | % Improvement in | | % Runtime |
|---|---|---|---|---|---|
| | SymMAX ™ | Scavenged | H₂S Scavenged | Runtime | Improvement |
| Composition | (w/w %) | (lbs/gal) | over control | (mins) | over control |
| Control Composition 1 | 0.0% | 0.35 | NA | 88 | NA |
| Composition 1 | 14.0% | 0.40 | 14.3% | 100 | 13.6% |
| Composition 2 | 20.0% | 0.46 | 31.4% | 114 | 29.5% |
| Composition 3 | 26.0% | 0.45 | 28.6% | 111 | 26.1% |
| Composition 4 | 32.0% | 0.42 | 20.0% | 105 | 19.3% |
| Composition 5 | 37.5% | 0.37 | 5.7% | 92 | 4.5% |

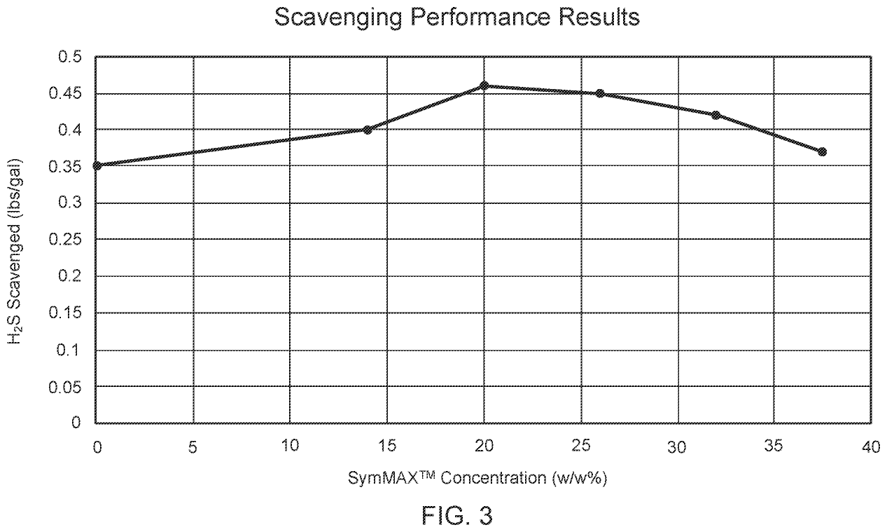

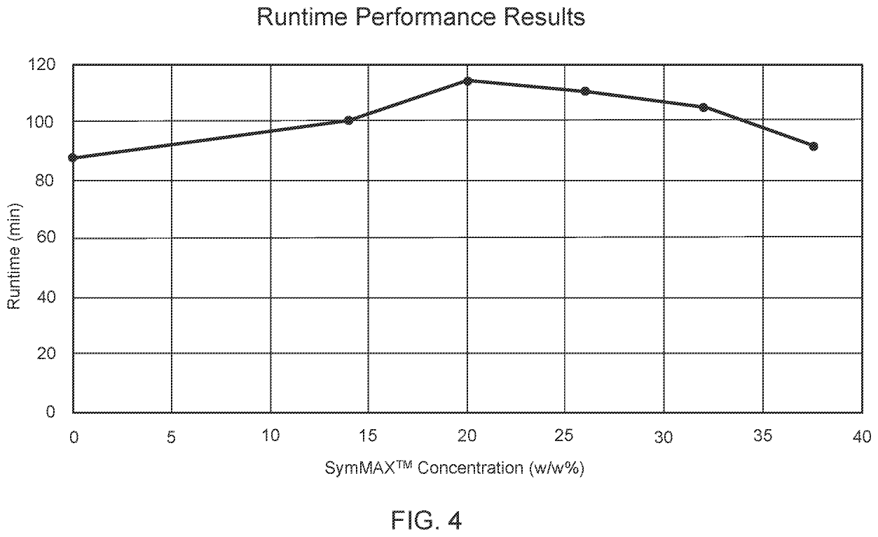

The amount of H₂S scavenged vs. SymMAX™ supramolecular host water mixture concentration is displayed in FIG. 3, and the runtime vs. SymMAX™ supramolecular host water mixture concentration is displayed in FIG. 4. From the data it is apparent that SymMAX™ supramolecular host water mixture improves both the scavenging ability as well as the runtime of MEA triazine. It is also clear that this improvement is dependent on SymMAX™ supramolecular host water mixture concentration and can be optimized for a particular chemistry.

### Example 4: Preparation of Additional MEA Triazine Compositions

Different exemplary compositions were prepared using the components and quantities shown in Table 3. The compositions were made by using commercially available distilled water, MEA triazine, tetrasodium EDTA, and SymMAX™ supramolecular host water mixture commercially available from Shotwell Hydrogenics. Tetrasodium EDTA was added to the solution to chelate any hard-mineral ions that could precipitate from the SymMAX™ supramolecular host water mixture due to the high pH of MEA triazine.

A control composition was also prepared using the components and quantities shown in Table 3 below, but SymMAX™ supramolecular host water mixture was replaced with distilled water.

TABLE 3
ADDITIONAL MEA TRIAZINE COMPOSITIONS

| | Distilled Water | EDTA¹ | MEA Triazine² | SymMAX ™³ | % H₂S |
|---|---|---|---|---|---|
| Composition | (w/w %) | (w/w %) | (w/w %) | (w/w %) | Scavenger |
| Composition 6 | 57.05% | 0.5% | 32.25% | 10.2% | 20 |
| Control Composition 6 | 67.75% | | 32.25% | | 20 |
| Composition 7 | 35.81% | 0.5% | 48.39% | 15.3% | 30 |
| Control Composition 7 | 51.61% | | 48.39% | | 30 |
| Composition 8 | 14.58% | 0.5% | 64.52% | 20.4% | 40 |
| Control Composition 8 | 35.48% | | 64.52% | | 40 |

¹Commercially available as Dissolvine ® E39 from Nouryon (39% Tetrasodium EDTA Water Solution)
²Commercially available as MEA Triazine from Hexion (62% MEA Triazine Water Solution)
³Commercially available from Shotwell Hydrogenics, LLC

### Example 5: Performance Test of Compositions of Example 4

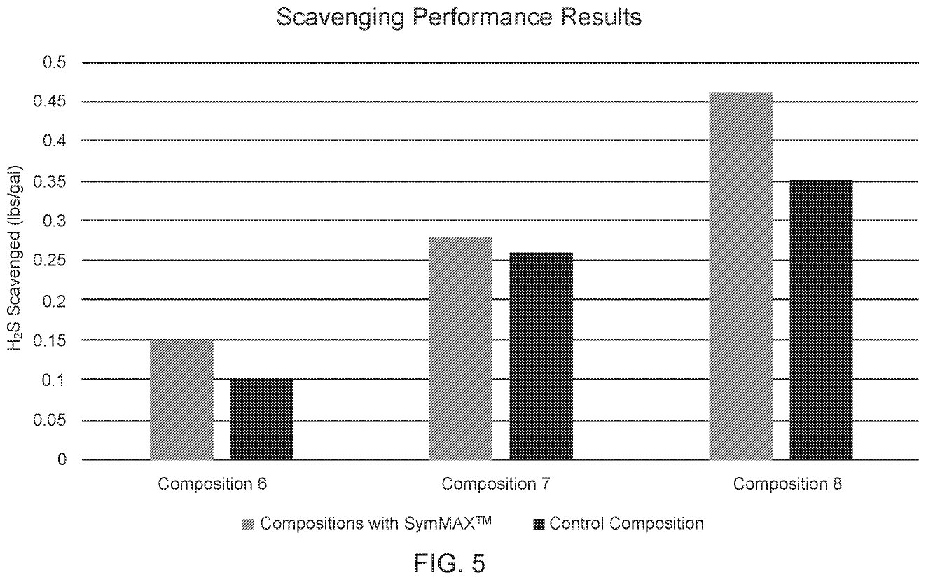

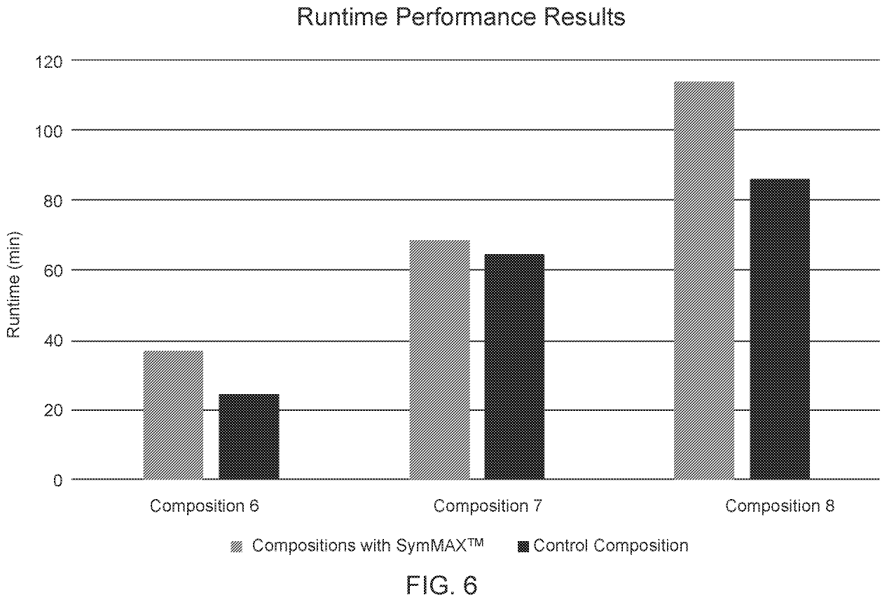

The H₂S scavenging performance of the compositions in Example 4 were evaluated at a third-party laboratory (Lightning Corrosion Lab in Tomball, Tex.) according to the procedure described below. Samples were diluted with distilled water to 1% v/v into a 300 mL sample for testing. A gas cylinder containing 0.2% H₂S and 5% CO₂ in 94.8% v/v methane was connected to a sparge tube which was immersed in the test sample. Gas was fed to the sparge tube at a rate of 475 cc/min, and effluent gases were routed to an H₂S monitor. The test was run until breakthrough, or the point at which the H₂S monitor recorded an H₂S concentration of 15 ppm. The amount of time taken to reach breakthrough was referred to as the runtime. Results for H₂S scavenged and H₂S runtime are provided below in Table 4 and Table 5, and shown in FIGS. 5 and 6.

TABLE 4
H₂S SCAVENGED RESULTS

| | H₂S Scavenged (lb/gal) | | |
|---|---|---|---|
| | | Control | |
| | Composition | Composition | |
| | with | without | % |
| Compositions | SymMAX ™ | SymMAX ™ | Increase |
| Composition 6 Series | 0.15 | 0.10 | 50% |
| Composition 7 Series | 0.28 | 0.26 | 8% |
| Composition 8 Series | 0.46 | 0.35 | 31% |

TABLE 5
H₂S RUNTIME RESULTS

| | H₂S Runtime (min) | | |
|---|---|---|---|
| | | Control | |
| | Composition | Composition | |
| | with | without | % |
| Compositions | SymMAX ™ | SymMAX ™ | Increase |
| Composition 6 Series | 37 | 25 | 48% |
| Composition 7 Series | 69 | 65 | 6% |
| Composition 8 Series | 114 | 86 | 33% |

As seen in Table 4 there was an increase of 8% to 50% of pounds of H₂S scavenged per gallon of product used between Composition 6 and Composition 7, and as observed in Table 5 there was an increase of 6% to 48% in total runtime to breakthrough between Composition 6 and Composition 7.

### Example 6: Preparation of MMA Triazine Compositions

Different exemplary compositions were prepared using the components and quantities shown in Table 6. The composition was made by using commercially available distilled water, MMA triazine, and SymMAX™ supramolecular host water mixture commercially available from Shotwell Hydrogenics.

TABLE 6
MMA TRIAZINE COMPOSITIONS

| | Composition 9 | Control Composition 9 |
|---|---|---|
| Component | (w/w %) | (w/w %) |
| Distilled water | | 50.0% |
| MMA Triazine¹ | 50.0% | 50.0% |
| SymMAX ™ | 50.0% | |

¹Commercially available as Sulfix 9252 from Hexion (40% MMA Triazine Water Solution)

### Example 7: Performance Test of Compositions of Example 6

The H₂S scavenging performance of the compositions in Example 6 were evaluated at a third-party laboratory (Oilfield Labs of America in Midland, Tex.) according to the procedure described below. The scavengers were diluted to 25% w/w with distilled water, and 80 mL of the diluted sample was utilized for testing. A gas cylinder containing 10% v/v H₂S in nitrogen was fed to a sparge tube at a rate of 240 cc/min, and the sparge tube was immersed in the scavenger being tested. The gas was sparged into the sample, and effluent gases were routed to an H₂S monitor. When the concentration of H₂S in the effluent gas reached 1500 ppm, the H₂S monitor was disconnected from the system to avoid damaging it, but sparging was continued. The tests were run for a total of 225 minutes, which resulted in the scavengers treating a total of 1.38 lbs of H₂S per gallon of scavenger. This was done to overspend the scavenger and force the precipitation of dithiazine solids. After 225 minutes, the test was stopped, and the samples were transferred to glass bottles and placed in a 140° F. oven for 48 hours. The samples were then removed and allowed to cool to ambient temperature. The solids thus produced were filtered, dried, and weighed.

These results, along with the runtimes and H₂S scavenged at 1500 ppm are shown in Table 7.

TABLE 7
MMA TRIAZINE PERFORMANCE RESULTS

| | | % H₂S | | | | |
|---|---|---|---|---|---|---|
| | H₂S | Scavenged | | | Solids² | % Solids |
| | Scavenged¹ | Improvement | Runtime¹ | Solids² | (w/w %) of | Improvement |
| Composition | (lbs/gal) | over control | (mins) | (grams) | scavenger | over control |
| Composition 9 | 0.57 | 11.8% | 93 | 4.4 | 8.2% | 31.8% |
| Control | 0.51 | NA | 84 | 6.5 | 12.0% | NA |
| Composition 9 | | | | | | |

¹When the effluent gas reached an H₂S concentration of 1500 ppm
²At 225 minutes

As observed in Table 7, the inclusion of SymMAX™ supramolecular host water mixture resulted in a 11.8% improvement in pounds of H₂S scavenged per gallon of product and a 10.7% increase in total runtime performance. Additionally, Composition 9 resulted in a 31.8% reduction in solid precipitation compared to the control.

### Example 8: Precipitation of Solids With MEA Triazine

Breakthrough tests were conducted with the goal of inducing the formation of dithiazine as a solid precipitant. The H₂S scavenging performance of Composition 2 in Example 1 and a control composition were evaluated at a third-party laboratory (Oilfield Labs of America in Midland, Tex.) according to the procedure described below. The scavengers were diluted to 25% w/w with distilled water, and 80 mL of the diluted sample was utilized for testing. A gas cylinder containing 10% v/v H₂S in nitrogen was fed to a sparge tube at a rate of 240 cc/min, and the sparge tube was immersed in the scavenger being tested. At intervals, a 20 mL portion of the sample was removed from the reaction vessel and transferred to a glass bottle. The intervals correspond to specific amounts of H₂S that the scavenger must treat and can be found in Table 8. After the last 20 mL portion had been transferred to a glass bottle, the samples were placed in a 140° F. oven for 48 hours. The samples were then removed from the oven and allowed to cool to ambient temperature. The solids thus produced were filtered, dried, and weighed.

TABLE 8
SOLIDS PRECIPITATION RESULTS

| | Sample | H₂S | Total | Difference | |
|---|---|---|---|---|---|
| | Runtime | Treated | Solids | From Control | |
| Sample | (mins) | (mols) | (grams) | (grams) | |
| Control | 201 | 2.20 | 0.005 | NA | |
| Composition 2 | 228 | 2.60 | 0.051 | NA | |
| | 252 | 3.10 | 2.141 | NA | |
| | 270 | 3.90 | 15.201 | NA | |
| Composition 2 | 201 | 2.20 | 0.020 | 0.01 | |
| | 228 | 2.60 | 0.048 | −0.00 | (−6.1%) |
| | 252 | 3.10 | 0.343 | −1.80 | (−84.0%) |
| | 270 | 3.90 | 10.943 | −4.26 | (−28.0%) |

As can be seen in Table 8, Control Composition 2 produced significantly more solids than Composition 2, particularly after 2.6 mols of H₂S had been treated. At 3.1 mols, Composition 2 had produced 84% less solid dithiazine than the control composition. At 3.9 mols of H₂S, Composition 2 had produced 28% less solid dithiazine overall than the control composition. Based on the mass of solids produced, the solids mitigating effect of SymMAX™ supramolecular host water mixture appears to increase as the scavenger becomes more and more spent.

### Example 9: Performance in Bubble Tower Under Normal Field Conditions

A field trial was conducted on a 2 well battery in the Delaware Basin. Gas containing 100-120 ppm of H₂S was routed from the well through a 1000-gallon bubble tower. The gas flow rate was such that the runtime for a 40% MEA triazine solution was 21 days±1 day with a breakthrough point set at 10 ppm. Composition 5 was loaded into the tower and allowed to treat the gas until the concentration of H₂S coming from the outlet of the tower was determined to be 10 ppm. At this point, Composition 5 had a runtime of 28 days, or 33% longer. No solids were detected when the tower was drained.

The pounds of H₂S scavenged during the trial was determined from the gas flow rate, temperature, and pressure, as well as H₂S readings at the bubble tower inlet. Runtimes and H₂S scavenged information can be found in Table 9.

TABLE 9
FIELD TRIAL 1 RESULTS

| | | % | | % |
|---|---|---|---|---|
| | | Improvement | H₂S | Improvement |
| H₂S | Runtime | over Control | Scavenged | over Control |
| Scavenger | (days) | Composition | (lbs/gal) | Composition 5 |
| Composition 5 | 28.0 | 33.3% | 0.76 | 26.7% |
| Control | 21.0 | NA | 0.60 | NA |
| Composition | | | | |
| (40% MEA | | | | |
| Triazine) | | | | |

An additional field trial was conducted on a 4 well battery in the Delaware Basin. Gas containing 400-700 ppm of H₂S was routed from the well through a 2450-gallon bubble tower. The gas flow rate was such that the runtime for 40% MEA triazine was 14 days±1 day with a breakthrough point set at 10 ppm. Composition 5 was loaded into the tower and allowed to treat the gas until the concentration of H₂S coming from the outlet of the tower was determined to be 10 ppm. At this point, Composition 5 had a runtime of 16.5 days, or 18% longer. No solids were detected when the tower was drained. Runtimes and H₂S scavenged information can be found in Table 10.

TABLE 10
FIELD TRIAL 2 RESULTS

| | | % | | % |
|---|---|---|---|---|
| | | Improvement | H₂S | Improvement |
| H₂S | Runtime | over Control | Scavenged | over Control |
| Scavenger | (days) | Composition | (lbs/gal) | Composition 2 |
| Composition 5 | 16.5 | 17.9% | 1.00 | 12.4% |
| Control | 14.0 | NA | 0.89 | NA |
| Composition | | | | |
| (40% MEA | | | | |
| Triazine) | | | | |

A field trial was conducted at the same 2 well battery tested before, but approximately a month after the first trial was conducted. Composition 5 had a runtime of 29.4 days, or 40% longer. Similar results as the original trial were confirmed. Runtimes and H₂S scavenged information can be found in Table 11.

TABLE 11
FIELD TRIAL 3 RESULTS

| | | % | | % |
|---|---|---|---|---|
| | | Improvement | H₂S | Improvement |
| H₂S | Runtime | over Control | Scavenged | over Control |
| Scavenger | (days) | Composition | (lbs/gal) | Composition |
| Composition 5 | 29.5 | 40.5% | 0.63 | 36.9% |
| Control | 21.0 | NA | 0.46 | NA |
| Composition | | | | |
| (40% MEA | | | | |
| Triazine) | | | | |

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

What is claimed is:

1. A sulfur scavenging composition comprising:
a hydrogen sulfide (H₂S) scavenger;
a supramolecular host chemical or a supramolecular guest chemical configured to engage in host-guest chemistry with the H₂S scavenger; and
a solvent.

2. The composition of claim 1, wherein the H₂S scavenger comprises one or more of an alkylamine or alkanolamine; an aldehyde; a reaction product between an alkylamine or alkanolamine and an aldehyde; an oxidizer; a transition metal salt, a transition metal carboxylate, or a transition metal oxide where the transition metal is either iron or zinc; a caustic; or any combination of the foregoing categories or the components within one or more categories.

3. The composition of claim 2, wherein the H₂S scavenger comprises a reaction product between an alkylamine or alkanolamine and an aldehyde.

4. The composition of claim 3, wherein the reaction product comprises monoethanoloamine (MEA) triazine or monomethylamine (MMA) triazine.

5. The composition of claim 1, further comprising one or more of a sequestrant, a scale inhibitor, a surfactant, a corrosion inhibitor, an anti-foamer, a freeze point depressant, a pour point depressant, a diluent, or any combination of the foregoing categories or the components within one or more categories.

6. The composition of claim 5, wherein the composition further comprises a sequestrant, which comprises ethylenediaminetetraacetic acid (EDTA) or a salt thereof.

7. The composition of claim 6, wherein the freeze point depressant is present and comprises methanol.

8. The composition of claim 1, wherein the solvent comprises water, methanol, ethanol, or any combination thereof.

9. The composition of claim 1, wherein the H₂S scavenger is present in an amount of about 1 percent to about 90 percent by weight of the composition.

10. The composition of claim 1, wherein the supramolecular host chemical or supramolecular guest chemical is present in an amount of about 1 percent to about 90 percent by weight of the composition.

11. The composition of claim 1, wherein the solvent is present in an amount of 0.5 percent to about 80 percent by weight of the composition.

12. A method of preparing the sulfur scavenging composition of claim 1, comprising:
forming a mixture of the solvent and the H₂S scavenger; and
adding the supramolecular host chemical or the supramolecular guest chemical to the mixture to form the sulfur scavenging composition.

13. A method for scavenging hydrogen sulfide (H₂S) in a hydrocarbon fluid comprising:
adding an effective amount of a sulfur scavenging composition to the hydrocarbon fluid, the sulfur scavenging composition comprising:
an H₂S scavenger;
a supramolecular host chemical or a supramolecular guest chemical configured to engage in host-guest chemistry with the H₂S scavenger; and
an aqueous solvent; and
reducing an amount of H₂S in the hydrocarbon fluid.

14. The method of claim 13, wherein the composition is added to the hydrocarbon fluid by injection into a flow line or by pre-loading into a bubble tower.

15. The method of claim 13, further comprising suppressing formation of precipitated solids in the hydrocarbon fluid.

16. The method of claim 15, wherein the precipitated solids are present in the hydrocarbon fluid in an amount of less than about 5 percent by weight of the H₂S scavenger after 3 moles of H₂S have reacted per mole of the H₂S scavenger.

17. The method of claim 13, wherein the H₂S scavenger is selected to comprise one or more of an alkylamine or alkanolamine; an aldehyde; a reaction product between an alkylamine or alkanolamine and an aldehyde; an oxidizer; a transition metal salt, a transition metal carboxylate, or a transition metal oxide where the transition metal is either iron or zinc; a caustic; or any combination of the foregoing categories or the components within one or more categories.

18. The method of claim 17, wherein the H₂S scavenger is selected to comprise a reaction product between an alkylamine or alkanolamine and an aldehyde, which reaction product comprises monoethanoloamine (MEA) triazine or monomethylamine (MMA) triazine.

19. The method of claim 13, further comprising adding a sequestrant, a scale inhibitor, a surfactant, a corrosion inhibitor, an anti-foamer, a freeze point depressant, a pour point depressant, a diluent, or any combination thereof to the composition.

20. The method of claim 19, wherein a sequestrant is added to the composition, and the sequestrant comprises ethylenediaminetetraacetic acid (EDTA) or a salt thereof.

21. The method of claim 13, wherein the H₂S scavenger is present in an amount of about 1 percent to about 90 percent by weight of the composition and wherein the supramolecular host chemical or the supramolecular guest chemical is present in an amount of about 1 percent to about 90 percent by weight of the composition.
